(19) United States
(12) Patent Application Publication
(10) Pub. No.: US 2026/0302936 A1
(43) Pub. Date: Oct. 1, 2026

(54) INDUCTOR CURRENT EMULATION CIRCUIT FOR MULTI-LEVEL SWITCHING CONVERSION CIRCUIT AND EMULATION CONTROL METHOD THEREOF

(71) Applicant: Richtek Technology Corporation, Zhubei City (TW)

(72) Inventors: Chia-Jung Chang, Hsinchu (TW); Jiing-Horng Wang, Hsinchu (TW); Jian-Lin Huang, Yunlin (TW); Yuan-Yen Mai, Taipei (TW); Kwan-Jen Chu, Hsinchu (TW)

(21) Appl. No.: 19/315,756

(22) Filed: Sep. 1, 2025

(30) Foreign Application Priority Data
Mar. 25, 2025 (TW) 114111318

(51) Int. Cl. H02M 3/07

(52) U.S. Cl. CPC H02M 3/07

(57) ABSTRACT

An inductor current emulation circuit emulates an inductor current of a multi-level switching conversion circuit periodically switching a capacitor and an inductor between plural electrical connection states according to plural switching signals, thereby performing power conversion between a first voltage and a second voltage. The inductor current emulation circuit includes: a selection circuit selecting plural candidate voltages according to plural state signals to generate a first emulation signal; and a filtering circuit generating a second emulation signal according to a difference between the first emulation signal and a bias voltage value, thereby emulating the inductor current. The plural state signals relate to the plural switching signals, and each of the plural state signals corresponds to one of the plural electrical connection states. Each of the plurality of candidate voltages relates to (1) the first voltage, (2) the second voltage, (3) a ground potential, or (4) a linear combination thereof.

### CROSS REFERENCE

The present invention claims priority to the TW patent application Ser. No. 114111318, filed on Mar. 25, 2025.

### BACKGROUND OF THE INVENTION

### Field of Invention

The present invention relates to an inductor current emulation circuit, and particularly to an inductor current emulation circuit for use in a multi-level switching conversion circuit. The present invention also relates to a control method for controlling the inductor current emulation circuit described above.

### Description of Related Art

FIG. 1 illustrates three-level boost switching conversion circuit of the prior art. As shown in FIG. 1, the three-level boost switching conversion circuit includes four switching transistors Q1, Q2, Q3, and Q4, which are switched according to controls of a plurality of switching signals SQ1 to SQ4, so that an inductor L and a capacitor CFLY are switched between different electrical connection states, thereby achieving a power conversion between an input voltage VIN and an output voltage VOUT. In this architecture, a switching node LX switches between multiple voltages, for example, between a voltage of the capacitor CFLY, the output voltage VOUT, and a ground potential.

In the prior art three-level boost switching conversion circuit, since the power stage includes four switching transistors, in order to sense an inductor current flowing through the inductor L1, conventionally it is necessary to individually sense currents of each switching transistor, and then combine the sensed currents into the inductor current. As shown in FIG. 1, a current sensing circuit 90 generates a current sensing signal VCS by combining switching current signals CS1 to CS4, which are generated according to the currents sensed from the respective switching transistors. However, such a sensing approach has certain drawbacks. For example, current sensing of different switching transistors may have different gains and offsets, which results in the combined inductor current being inaccurate. In addition, because current conduction paths of different switching transistors are different, the combined current signal may be affected by parasitic effects of the circuit, thereby limiting the accuracy of inductor current sensing.

Furthermore, the three-level boost switching conversion circuit of the prior art typically employs a conventional current sensing circuit, such as a sensing resistor connected in series on a switching path, or current sensing performed by utilizing an inductor DCR (Direct Current Resistance). However, the sensing resistor approach introduces additional power loss, while the DCR current sensing approach is constrained by the DCR value of the inductor and further requires an additional calibration circuit to improve sensing accuracy. Accordingly, these approaches present inherent limitations and cannot simultaneously satisfy the requirements of accuracy and low power consumption.

### SUMMARY OF THE INVENTION

From one perspective, the present invention provides an inductor current emulation circuit, configured to emulate an inductor current of a multi-level switching conversion circuit, wherein the multi-level switching conversion circuit is configured to periodically switch a capacitor and an inductor between a plurality of electrical connection states based on a plurality of switching signals in accordance with a duty cycle, thereby performing power conversion between a first voltage and a second voltage; the inductor current emulation circuit comprising: a selection circuit, configured to select a plurality of candidate voltages according to a plurality of state signals to generate a first emulation signal; and a filtering circuit, configured to generate a second emulation signal according to a difference between the first emulation signal and a bias voltage value, thereby emulating the inductor current; wherein the difference between the first emulation signal and the bias voltage value is positively correlated with an inductor voltage across the inductor corresponding to one of the plurality of electrical connection states; wherein the plurality of state signals are associated with the plurality of switching signals, and each of the plurality of state signals corresponds to a corresponding one of the plurality of electrical connection states, and each of the plurality of candidate voltages is associated with (1) the first voltage, (2) the second voltage, (3) a ground potential, or (4) a linear combination thereof.

In one embodiment, the bias voltage value is positively correlated with an average voltage value of the second emulation signal.

In one embodiment, the average voltage value of the second emulation signal is positively correlated with the second voltage.

In one embodiment, the plurality of state signals include a first state signal, a second state signal, a third state signal, a fourth state signal, and a fifth state signal, respectively corresponding to the following states: (1) when the first state signal is asserted, the first emulation signal is positively correlated with the first voltage; (2) when the second state signal is asserted, the first emulation signal is positively correlated with a difference between the first voltage and the second voltage; (3) when the third state signal is asserted, the first emulation signal is positively correlated with a difference between the first voltage and one-half of the second voltage; (4) when the fourth state signal is asserted, the first emulation signal is positively correlated with the difference between the first voltage and one-half of the second voltage; or (5) when the fifth state signal is asserted, the first emulation signal is positively correlated with the ground potential.

In one embodiment, the plurality of electrical connection states of the capacitor and the inductor respectively correspond to the following: (1) when the first state signal is asserted, the inductor is electrically connected between the first voltage and the ground potential, and an upper end and a lower end of the capacitor are floating and electrically connected to the ground potential, respectively; (2) when the second state signal is asserted, the inductor is electrically connected between the first voltage and the second voltage, and the upper end and lower end of the capacitor are electrically connected to the second voltage and floating, respectively; (3) when the third state signal is asserted, the inductor and the capacitor are electrically connected in series between the first voltage and the ground potential; (4) when the fourth state signal is asserted, the inductor and the capacitor are electrically connected in series between the first voltage and the second voltage; or (5) when the fifth state signal is asserted, the inductor is electrically connected between the first voltage and floating, and the capacitor is floating.

In one embodiment, the first emulation signal has a first emulation voltage value during the first state signal being asserted, a second emulation voltage value during the second state signal being asserted, and a third emulation voltage value during the third state signal being asserted or the fourth state signal; wherein the average voltage value of the second emulation signal is determined based on: when the duty cycle is greater than ½, the average voltage value is determined according to the first emulation voltage value, the third emulation voltage value, and the duty cycle; or when the duty cycle is less than ½, the average voltage value is determined according to the second emulation voltage value, the third emulation voltage value, and the duty cycle.

In one embodiment, the filtering circuit includes: a voltage-to-current conversion circuit, configured to generate a filtering current according to a difference between the first emulation signal and the average voltage value of the second emulation signal, thereby emulating the inductor voltage; and an integration capacitor, configured to generate the second emulation signal based on an integration of the filtering current, thereby emulating the inductor current.

In one embodiment, the voltage-to-current conversion circuit includes a filtering resistor configured to generate the filtering current, one end of the filtering resistor being configured to receive the first emulation signal, thereby generating the second emulation signal at the other end of the filtering resistor, the other end being coupled to the integration capacitor.

In one embodiment, the selection circuit includes a plurality of selection switches, grouped into a first selection switch set, a second selection switch set, and a third selection switch set, and wherein the plurality of candidate voltages include first, second, third, fourth, and fifth candidate voltages; wherein the plurality of selection switches operate as follows: the first selection switch set is configured to select the first candidate voltage when the second state signal is asserted, and is configured to select the second candidate voltage when the first, third, or fourth state signal is asserted, to generate a first sub-emulation signal; the second selection switch set is configured to select the third candidate voltage when the first state signal is asserted, and is configured to select the fourth candidate voltage when the second, third, or fourth state signal is asserted, to generate a second sub-emulation signal; and the third selection switch set is configured to select the fifth candidate voltage when the fifth state signal is asserted; wherein the first emulation signal is generated according to a voltage division between the first sub-emulation signal and the second sub-emulation signal when the first, second, third, or fourth state signal is asserted, and is generated according to the fifth candidate voltage when the fifth state signal is asserted.

In one embodiment, the selection circuit further comprises: a logic circuit, configured to generate a plurality of control signals according to the plurality of state signals to control switching of the plurality of selection switches, thereby selecting the plurality of candidate voltages.

From another perspective, the present invention provides an emulation control method, configured to emulate an inductor current of a multi-level switching conversion circuit, wherein the multi-level switching conversion circuit is configured to periodically switch a capacitor and an inductor between a plurality of electrical connection states based on a plurality of switching signals in accordance with a duty cycle, thereby performing power conversion between a first voltage and a second voltage; the emulation control method comprising: selecting a plurality of candidate voltages according to a plurality of state signals to generate a first emulation signal; and generating a second emulation signal according to a difference between the first emulation signal and a bias voltage value, thereby emulating the inductor current; wherein the difference between the first emulation signal and the bias voltage value is positively correlated with an inductor voltage across the inductor corresponding to one of the plurality of electrical connection states; wherein the plurality of state signals are associated with the plurality of switching signals, each of the plurality of state signals corresponds to a corresponding one of the plurality of electrical connection states, and each of the plurality of candidate voltages is associated with (1) the first voltage, (2) the second voltage, (3) a ground potential, or (4) a linear combination thereof.

The inductor current emulation circuit of the present invention generates an emulation voltage signal by a selection circuit selecting corresponding candidate voltages according to a plurality of state signals, and further generates an emulation signal of an inductor current through filtering processing. The inductor current emulation circuit of the present invention can avoid the influence of gain differences in current sense of different switches, and can reduce the effects of power loss and parasitic effects, thereby facilitating accurate inductor current sensing of the multi-level switching conversion circuit while ensuring stability against gain differences, power loss, and parasitic effects.

The objectives, technical details, features, and effects of the present invention will be better understood with regard to the detailed description of the embodiments below, with reference to the attached drawings.

### BRIEF DESCRIPTION OF THE DRAWINGS

FIG. 1 illustrates a three-level boost switching conversion circuit of the prior art.

FIG. 2 illustrates a block diagram of a multi-level switching conversion circuit and an inductor current emulation circuit according to an embodiment of the present invention.

FIG. 3 illustrates a schematic diagram of the inductor current emulation circuit according to an embodiment of the present invention.

FIG. 4 illustrates a schematic diagram of the inductor current emulation circuit according to a specific embodiment of the present invention.

FIG. 5 illustrates a schematic diagram of a logic circuit according to a specific embodiment of the present invention.

FIG. 6A illustrates a table of signals related to inductor current emulation in different switching states of the multi-level switching conversion according to an embodiment of the present invention.

FIG. 6B illustrates a table of numerical values of signals related to inductor current emulation in different switching states of the multi-level switching conversion circuit according to a specific embodiment of the present invention.

FIG. 7 illustrates an operation waveform diagram of the multi-level switching conversion circuit and the inductor current emulation circuit according to an embodiment of the present invention.

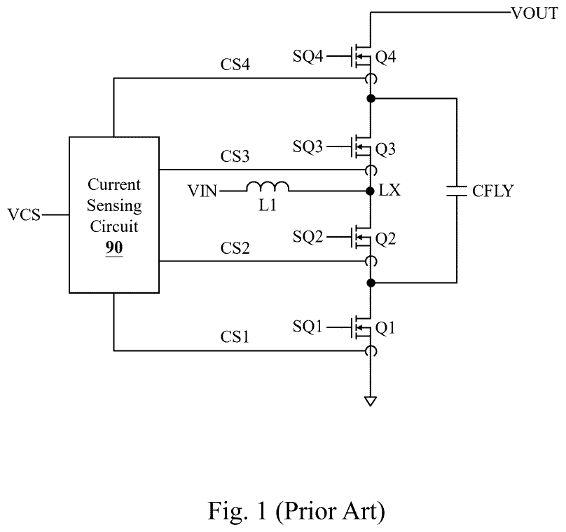

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

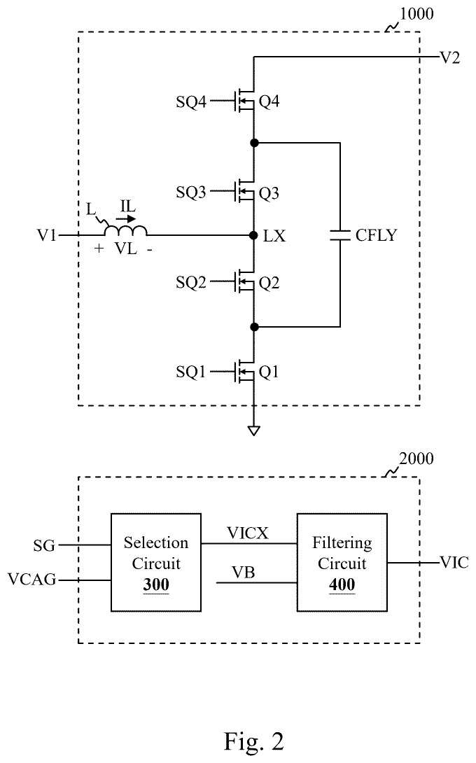

FIG. 2 illustrates a block diagram of a multi-level switching conversion circuit and an inductor current emulation circuit according to an embodiment of the present invention. In one embodiment, an inductor current emulation circuit 2000 is configured to emulate an inductor current IL of a multi-level switching conversion circuit 1000. The multi-level switching conversion circuit 1000 includes a plurality of switching transistors Q1 to Q4, configured to periodically switch a capacitor CFLY and an inductor L between a plurality of electrical connection states according to a plurality of switching signals SQ1 to SQ4 in accordance with a duty cycle, thereby performing power conversion between a first voltage V1 and a second voltage V2.

In one embodiment, one end (coupled to the switching node LX) of the inductor L in the multi-level switching conversion circuit is switched between multiple voltages. In this embodiment, the multi-level switching conversion circuit 1000 is a three-level switching conversion circuit. Specifically, the switching node LX is switched between a voltage across the capacitor CFLY, the second voltage V2, and a ground potential. In one specific embodiment, the first voltage V1 is an input voltage, and the second voltage V2 is an output voltage, such that the multi-level switching conversion circuit 1000 is a boost-type switching conversion circuit. The following embodiments are described with reference to a three-level boost-type switching conversion circuit as an example; however, the scope of the present invention is not limited thereto, and the inductor current emulation circuit of the present invention can also be applied to, for example, buck-type or other types of multi-level switching conversion circuits.

In one embodiment, the inductor current emulation circuit 2000 comprises a selection circuit 300 and a filtering circuit 400. In one embodiment, the selection circuit 300 is configured to select a plurality of candidate voltages VCAG according to a plurality of state signals SG to generate a first emulation signal VICX. The filtering circuit 400 is configured to generate a second emulation signal VIC according to a difference between the first emulation signal VICX and a bias voltage value VB, thereby emulating the inductor current IL.

In one embodiment, the difference between the first emulation signal VICX and the bias voltage value VB is positively correlated with an inductor voltage VL across the inductor L corresponding to the plurality of electrical connection states. Specifically, the first emulation signal VICX is positively correlated with the inductor voltage VL across the inductor L under different electrical connection states. Therefore, the inductor current IL can be further emulated through filtering processing.

In one embodiment, the plurality of state signals SG are associated with the plurality of switching signals SQ1 to SQ4, and each of the plurality of state signals SG corresponds to one of the plurality of electrical connection states. In other words, each of the plurality of state signals SG corresponds to one electrical connection state of the capacitor CFLY and the inductor L, thereby ensuring that the inductor current emulation circuit 2000 can generate a corresponding emulated current signal according to different switching states of the plurality of switching transistors Q1 to Q4. In one embodiment, each of the plurality of candidate voltages VCAG is associated with (1) the first voltage V1, (2) the second voltage V2, (3) the ground potential, or (4) a linear combination thereof. Specifically, according to the different switching states of the plurality of switching transistors Q1 to Q4, the selection circuit 300 selects a corresponding one of the plurality of candidate voltages VCAG, as will be described in detail hereinafter.

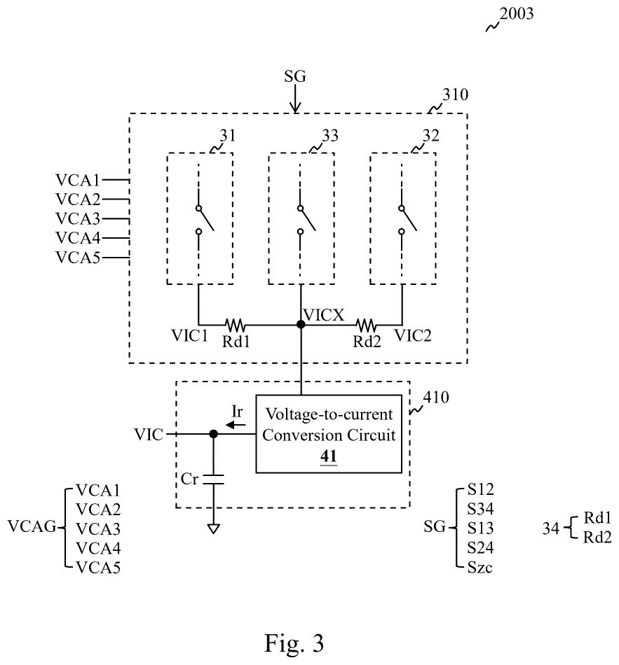

FIG. 3 illustrates a schematic diagram of the inductor current emulation circuit according to an embodiment of the present invention. The inductor current emulation circuit 2003 in FIG. 3 is a specific embodiment of the inductor current emulation circuit 2000 in FIG. 2. As shown in FIG. 3, in one embodiment, the selection circuit 310 includes a voltage division circuit 34 and a plurality of selection switches, and the plurality of selection switches are grouped into a first selection switch set 31, a second selection switch set 32, and a third selection switch set 33. In one embodiment, the filtering circuit 410 includes a voltage-to-current conversion circuit 41 and an integration capacitor Cr. In this embodiment, the voltage division circuit 34 includes resistors Rd1 and Rd2, configured to generate the first emulation signal VICX according to a voltage division between a first sub-emulation signal VIC1 and a second sub-emulation signal VIC2.

In one embodiment, the plurality of state signals SG include a first state signal S12, a second state signal S34, a third state signal S13, a fourth state signal S24, and a fifth state signal Szc. In one embodiment, the plurality of candidate voltages VCAG include first, second, third, fourth and fifth candidate voltages VCA1 to VCA5. In one embodiment, the first selection switch set 31 and the second selection switch set 32 are respectively configured, according to the plurality of state signals SG, to select at least one of the plurality of candidate voltages VCAG under different electrical connection states of the capacitor CFLY and the inductor L, thereby generating the first sub-emulation signal VIC1 and the second sub-emulation signal VIC2, respectively. In this embodiment, the third selection switch set 33 is configured, according to the plurality of state signals SG, to select at least one of the plurality of candidate voltages VCAG under one of the electrical connection states of the capacitor CFLY and the inductor L, as the first emulation signal VICX.

In one embodiment, the voltage-to-current conversion circuit 41 is configured to generate a filtering current Ir according to a difference between the first emulation signal VICX and an average voltage value VICavg of the second emulation signal VIC, thereby emulating the inductor voltage VL. In one embodiment, the integration capacitor Cr is configured to generate the second emulation signal VIC according to an integration of the filtering current Ir, thereby emulating the inductor current IL. In one embodiment, the filtering current Ir may alternatively be another electrical characteristic instead of a current.

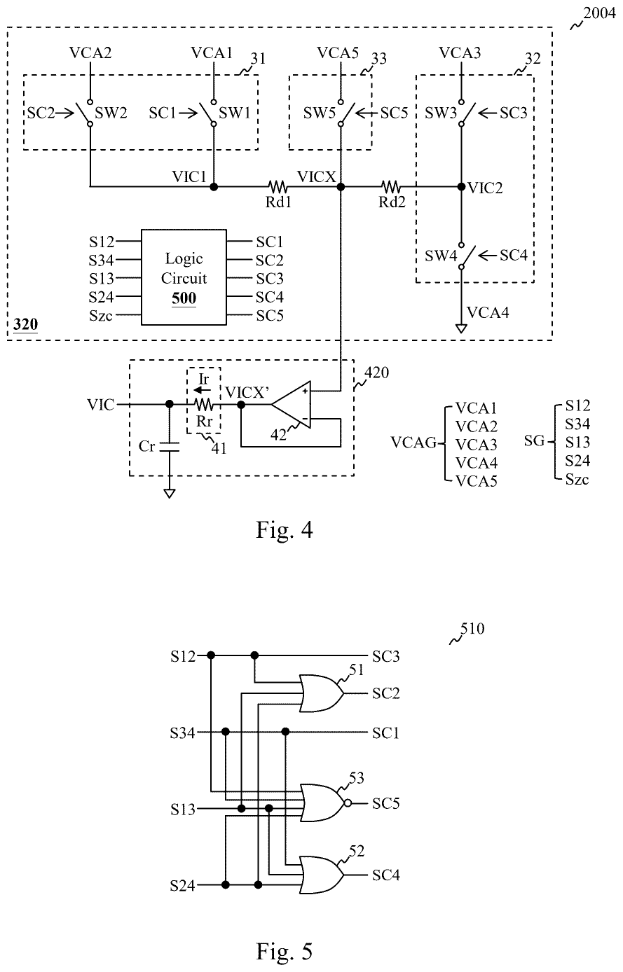

FIG. 4 illustrates a schematic diagram of the inductor current emulation circuit according to a specific embodiment of the present invention. The inductor current emulation circuit 2004 in FIG. 4 is a specific embodiment of the inductor current emulation circuit 2003 in FIG. 3. As shown in FIG. 4, in one embodiment, the selection circuit 320 further includes a logic circuit 500. In one specific embodiment, the first selection switch set 31 includes selection switches SW1 and SW2, the second selection switch set 32 includes selection switches SW3 and SW4, and the third selection switch set 33 includes selection switch SW5. In one embodiment, the logic circuit 500 is configured to generate a plurality of control signals SC1 to SC5 according to the plurality of state signals SG (i.e., the first state signal S12, the second state signal S34, the third state signal S13, the fourth state signal S24, and the fifth state signal Szc) to control switching of the plurality of selection switches SW1 to SW5, thereby selecting the plurality of candidate voltages VCAG.

As shown in FIG. 4, in one specific embodiment, the filtering circuit 420 further includes a single-stage amplifier 42, and the voltage-to-current conversion circuit includes a filtering resistor Rr. In one embodiment, the single-stage amplifier 42 is configured to generate a buffered first emulation signal VICX′ according to the first emulation signal VICX, wherein the buffered first emulation signal VICX′ is positively correlated with the first emulation signal VICX. Specifically, in this embodiment, the buffered first emulation signal VICX′ is a unity-gain buffered version of the first emulation signal VICX. In one embodiment, the filtering resistor Rr is configured to generate the filtering current Ir, wherein one end of the filtering resistor Rr is configured to receive the buffered first emulation signal VICX′, thereby generating the second emulation signal VIC at the other end of the filtering resistor Rr. In this embodiment, the other end of the filtering resistor Rr is coupled to the integration capacitor Cr. From one perspective, in this embodiment, the filtering resistor Rr is configured to generate the filtering current Ir according to a difference between the buffered first emulation signal VICX′ and the average voltage value VICavg of the second emulation signal VIC, thereby emulating the inductor voltage VL. From another perspective, a voltage across the filtering resistor Rr is configured to emulate the inductor voltage VL. In one embodiment, the integration capacitor Cr is configured to generate the second emulation signal VIC according to an integration of the filtering current Ir, thereby emulating the inductor current IL.

Referring also to FIG. 2, in the embodiment of FIG. 2, the second emulation signal VIC is generated according to the difference between the first emulation signal VICX and a bias voltage value VB, and in the specific embodiment of FIG. 4, the bias voltage value VB corresponds to the average voltage value VICavg of the second emulation signal VIC.

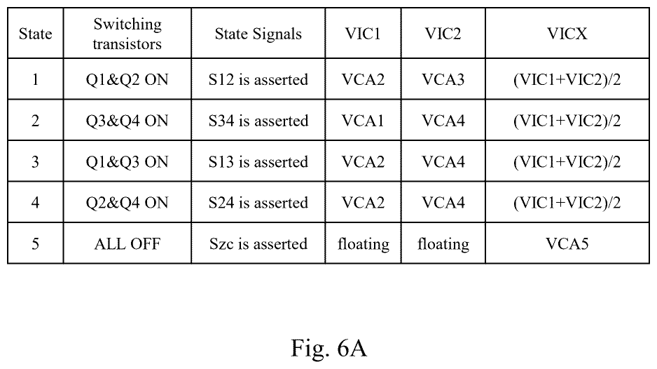

FIG. 5 illustrates a schematic diagram of a logic circuit according to a specific embodiment of the present invention. In one specific embodiment, as shown in FIG. 5, a logic circuit 510 includes OR gates 51 and 52, and a NOR gate 53. In one embodiment, the OR gate 51 is configured to generate a control signal SC2 according to the first state signal S12, the third state signal S13, and the fourth state signal S24. The OR gate 52 is configured to generate a control signal SC4 according to the second state signal S34, the third state signal S13, and the fourth state signal S24. The NOR gate 53 is configured to generate a control signal SC5 according to the first state signal S12, the second state signal S34, the third state signal S13, and the fourth state signal S24. In one embodiment, the control signal SC3 corresponds to the first state signal S12, and the control signal SC1 corresponds to the second state signal S34.

Referring to FIGS. 4 and 5, in one specific embodiment, the selection switch SW1 is turned on according to a control of the control signal SC1 when the second state signal S34 is asserted, to select the first candidate voltage VCA1. The selection switch SW2 is turned on according to a control of the control signal SC2 when the first state signal S12, the third state signal S13, or the fourth state signal S24 are asserted, to select the second candidate voltage VCA2. Consequently, the first sub-emulation signal VIC1 is generated according to the first candidate voltage VCA1 or the second candidate voltage VCA2. The selection switch SW3 is configured to select the third candidate voltage VCA3 according to a control of the control signal SC3 when the first state signal S12 is asserted. The selection switch SW4 is configured to select the fourth candidate voltage VCA4 according to a control of the control signal SC4 when the second state signal S34, the third state signal S13, or the fourth state signal S24 are asserted. Consequently, the second sub-emulation signal VIC2 is generated according to the third candidate voltage VCA3 or the fourth candidate voltage VCA4. The selection switch SW5 is configured to select the fifth candidate voltage VCA5 as the first emulation signal VICX according to a control of the control signal SC5 when the fifth state signal Szc is asserted.

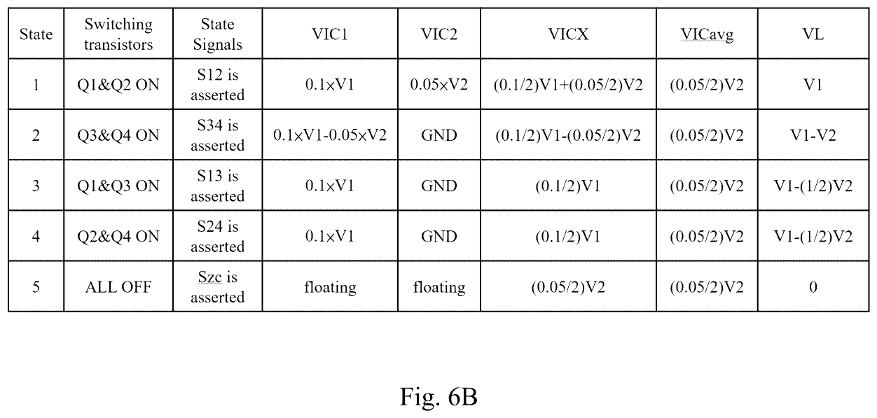

Referring to FIGS. 2, 4, 6A, and 6B, FIG. 6A illustrates a table of signals related to inductor current emulation in different switching states of the multi-level switching conversion circuit according to an embodiment of the present invention, and FIG. 6B illustrates a table of numerical values of signals related to inductor current emulation in different switching states of the multi-level switching conversion circuit according to a specific embodiment of the present invention. In one embodiment, the plurality of state signals SG correspond to the following states:

(1) State 1: When the switching signals SQ1 and SQ2 are asserted to respectively turn on the switching transistors Q1 and Q2, the inductor L is electrically connected between the first voltage V1 and the ground potential, and an upper end and a lower end of the capacitor CFLY are respectively floating and electrically connected to the ground potential. At this state (state 1), the first state signal S12 is asserted, and the first emulation signal VICX is positively correlated with the first voltage V1.

(2) State 2: When the switching signals SQ3 and SQ4 are asserted to respectively turn on the switching transistors Q3 and Q4, the inductor L is electrically connected between the first voltage V1 and the second voltage V2, and the upper end and the lower end of the capacitor CFLY are respectively electrically connected to the second voltage V2 and floating. At this state (state 2), the second state signal S34 is asserted, and the first emulation signal VICX is positively correlated with a difference between the first voltage V1 and the second voltage V2.

(3) State 3: When the switching signals SQ1 and SQ3 are asserted to respectively turn on the switching transistors Q1 and Q3, the inductor L and the capacitor CFLY are electrically connected in series between the first voltage V1 and the ground potential. At this state (state 3), the third state signal S13 is asserted, and the first emulation signal VICX is positively correlated with a difference between the first voltage V1 and one-half of the second voltage V2.

(4) State 4: When the switching signals SQ2 and SQ4 are asserted to respectively turn on the switching transistors Q2 and Q4, the inductor L and the capacitor CFLY are electrically connected in series between the first voltage V1 and the second voltage V2. At this state (state 4), the fourth state signal S24 is asserted, and the first emulation signal VICX is positively correlated with the difference between the first voltage V1 and one-half of the second voltage V2.

(5) State 5: When the plurality of switching signals SQ1 to SQ4 are all deasserted to turn off the plurality of switching transistors Q1 to Q4 respectively, the inductor L is electrically connected between the first voltage V1 and floating, and the upper end and the lower end of the capacitor CFLY are both floating. At this state (state 5), the fifth state signal Szc is asserted, and the first emulation signal VICX is positively correlated with the ground potential.

In one embodiment, in one switching period, the multi-level switching conversion circuit 1000 sequentially switches between the above state 1, state 3, state 1, and state 4 to operate in a continuous conduction mode (CCM) or a boundary conduction mode (BCM). In this embodiment, V1>(½×V2), and the duty cycle is greater than ½. In another embodiment, in one switching period, the multi-level switching conversion circuit 1000 sequentially switches between the above state 3, state 2, state 4, and state 2 to operate in the CCM or the BCM. In this embodiment, V1<(½×V2), and the duty cycle is less than ½.

In another embodiment, when the multi-level switching conversion circuit 1000 operates in a discontinuous conduction mode (DCM), between the switching periods described above, the multi-level switching conversion circuit 1000 further switches to state 5. It is noted that, during operation in one complete switching period of the multi-level switching conversion circuit 1000, both state 3 and state 4 are included, so that the capacitor CFLY can be electrically connected between the first voltage V1 and the ground potential, or between the first voltage V1 and the second voltage V2, by switching between different states. Thereby, the voltage across the capacitor CFLY equals one-half of the second voltage (½×V2) in a steady state, thereby maintaining power conversion between the first voltage V1 and the second voltage V2.

In one specific embodiment, as shown in FIGS. 4 and 6B, the fourth candidate voltage VCA4 corresponds to the ground potential. The first candidate voltage VCA1, the second candidate voltage VCA2, the third candidate voltage VCA3, and the fifth candidate voltage VCA5 can be expressed by the following Equations (1) to (4):

$$VCA 1 = 0.1 \times V 1 - 0.05 \times V 2 \qquad Equation ( 1 )$$

$$VCA 2 = 0.1 \times V 1 \qquad Equation ( 2 )$$

$$VCA 3 = 0.05 \times V 2 \qquad Equation ( 3 )$$

$$VCA 5 = 0.05 / 2 \times V 2 \qquad Equation ( 4 )$$

In one embodiment, the first emulation signal VICX is generated according to a voltage division between the first sub-emulation signal VIC1 and the second sub-emulation signal VIC2 when the first state signal S12, the second state signal S34, the third state signal S13, or the fourth state signal S24 is asserted, and is instead generated according to the fifth candidate voltage VCA5 when the fifth state signal Szc is asserted.

In one embodiment, the first emulation signal VICX has a first emulation voltage value VICX(1) during the first state signal S12 being asserted, a second emulation voltage value VICX(2) during the second state signal S34 being asserted, and a third emulation voltage value VICX(34) during either the third state signal S13 or the fourth state signal S24 being asserted.

In one embodiment, the average voltage value VICavg of the second emulation signal VIC is determined based on one of the following: when the duty cycle is greater than ½, the average voltage value VICavg is determined according to the first emulation voltage value VICX(1), the third emulation voltage value VICX(34), and the duty cycle; or when the duty cycle is less than ½, the average voltage value VICavg is determined according to the second emulation voltage value VICX(2), the third emulation voltage value VICX(34), and the duty cycle. In one specific embodiment, when the duty cycle is greater than ½, the average voltage value VICavg of the second emulation signal VIC can be expressed by the following Equation (5), and when the duty cycle is less than ½, the average voltage value VICavg of the second emulation signal VIC can be expressed by the following Equation (6).

$$VICavg = \frac{V I C X ( 1 ) * [ \frac{{T}_{S}}{2} ( 1 - D ) \cdot {T}_{S} ] + VICX ( 34 ) \cdot ( 1 - D ) \cdot {T}_{S}}{\frac{T s}{2}} \qquad Equation ( 5 )$$

$$VICavg = \frac{V I C X ( 2 ) * [ \frac{{T}_{S}}{2} - {DT}_{S} ] + V I C X ( 34 ) \cdot {DT}_{S}}{\frac{{T}_{S}}{2}} \qquad Equation ( 6 )$$

In Equations (5) and (6), Ts denotes the switching period of the multi-level switching conversion circuit 1000, and D denotes a duty cycle. In one specific embodiment, as shown in FIG. 6B, the average voltage value VICavg of the second emulation signal VIC in the calculation results of Equations (5) and (6) is equal to 0.025×V2. From Equations (5) and (6) and the above description, it is understood that the average voltage value VICavg is positively correlated with the second voltage V2. More specifically, in this embodiment, the average voltage value VICavg is positively correlated with the voltage across the capacitor CFLY.

It should be noted that, in one embodiment, as shown in FIG. 6B, the difference between the first emulation signal VICX and the average voltage value VICavg of the second emulation signal VIC is positively correlated with an inductor voltage VL. In other words, the difference between the first emulation signal VICX and the average voltage value VICavg of the second emulation signal VIC is positively correlated with a slope of the inductor current IL. In the embodiment of the present invention, a filtering current Ir can be expressed by the following Equation (7):

$$Ir = ( VICX - VICavg ) / Rr \qquad Equation ( 7 )$$

From Equation (7), it is understood that, in one embodiment, the second emulation signal VIC generated by integrating the filtering current Ir over an integration capacitor Cr can be used to emulate the inductor current IL.

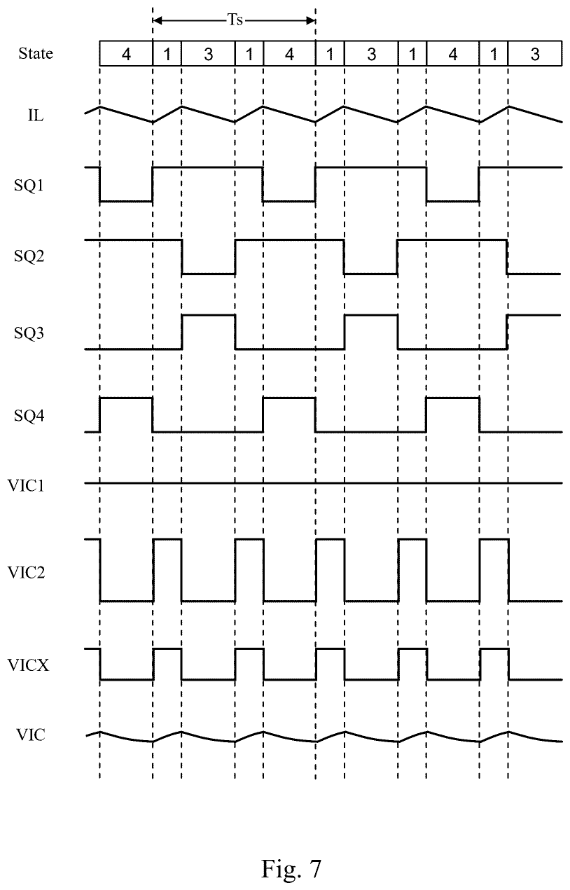

Referring to FIGS. 6B and 7 together, FIG. 7 illustrates an operation waveform diagram of the multi-level switching conversion circuit and the inductor current emulation circuit according to an embodiment of the present invention. As shown in FIG. 7, in one embodiment, the switching signal SQ1 and the switching signal SQ4 are in opposite phases, and the switching signal SQ2 and the switching signal SQ3 are in opposite phases. In this embodiment, when the multi-level switching conversion circuit 1000 operates in the CCM or the BCM, during the switching period Ts, the multi-level switching conversion circuit 1000 sequentially switches to the state 1, the state 3, the state 1, and the state 4, and then enters the next switching period. In this embodiment, since the first sub-emulation signal VIC1 has a fixed value (0.1×V1) in the states 1, 3, and 4, the waveform of VIC1 does not vary in level. The second sub-emulation signal VIC2 is at the ground potential in the states 3 and 4, and is equal to 0.05×V2 in the state 1, thus, the waveform of VIC2 is a square wave.

It should be noted that, in the embodiments of FIGS. 4 and 7, the first emulation signal VICX is a square wave (same as VICX′), while the second emulation signal VIC theoretically should exhibit a shape close to a triangular wave. However, in this embodiment, since an amplitude of the square wave of the first emulation signal VICX is much greater than an amplitude of the triangular wave exhibited by the second emulation signal VIC, accordingly, a voltage across the filtering resistor Rr, i.e., the first emulation signal VICX minus the second emulation signal VIC, is still approximately a square wave, which can be approximated as the first emulation signal VICX minus the average voltage value VICavg of the second emulation signal VIC. Furthermore, after integrating the voltage difference through the integration capacitor Cr, the resulting second emulation signal VIC still generally presents a triangular waveform. Accordingly, the present invention can achieve accurate emulation of the inductor current IL with a simple circuit structure.

It is noted that, in one embodiment, the multi-level circuit 1000 can switching conversion alternatively sequentially switch between the state 3, the state 2, the state 4, and the state 2 in a switching period. In one embodiment, when the multi-level switching conversion circuit 1000 operates in the DCM, it enters the state 5 at the end of each switching period (for example, at the end of each state 4 in FIG. 7), in which the plurality of switching signals SQ1 to SQ4 are all deasserted. The above operation details can be deduced from the embodiment of FIG. 7.

It is further noted that the inductor current IL is positively correlated with the inductor voltage VL, and the inductor voltage VL is positively correlated with (1) the first voltage V1, (2) the second voltage V2, (3) the ground potential, or (4) a linear combination (e.g., superposition) thereof. In one embodiment of the present invention, the selection circuit selects corresponding ones of a plurality of candidate voltages VCAG according to the switching states of the switching transistors Q1 to Q4, and the selected candidate voltages are used to generate the first emulation signal VICX. Subsequently, the filtering current Ir is generated according to the difference between the first emulation signal VICX and the average voltage value VICavg of the second emulation signal VIC. The filtering current Ir is then integrated through the integration capacitor to generate the second emulation signal VIC. Since the plurality of candidate voltages VCAG are also related to the first voltage V1, the second voltage V2, the ground potential, and a linear superposition thereof, the present invention can emulate the inductor current IL in the above manner without separately detecting currents of the plurality of switching transistors Q1 to Q4 and then combining them into the inductor current IL, thereby avoiding a problem of gain differences caused by current detection of different transistors.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. An inductor current emulation circuit, configured to emulate an inductor current of a multi-level switching conversion circuit, wherein the multi-level switching conversion circuit is configured to periodically switch a capacitor and an inductor between a plurality of electrical connection states based on a plurality of switching signals in accordance with a duty cycle, thereby performing power conversion between a first voltage and a second voltage; the inductor current emulation circuit comprising:
a selection circuit, configured to select a plurality of candidate voltages according to a plurality of state signals to generate a first emulation signal; and
a filtering circuit, configured to generate a second emulation signal according to a difference between the first emulation signal and a bias voltage value, thereby emulating the inductor current;
wherein the difference between the first emulation signal and the bias voltage value is positively correlated with an inductor voltage across the inductor corresponding to one of the plurality of electrical connection states;
wherein the plurality of state signals are associated with the plurality of switching signals, and each of the plurality of state signals corresponds to a corresponding one of the plurality of electrical connection states, and each of the plurality of candidate voltages is associated with (1) the first voltage, (2) the second voltage, (3) a ground potential, or (4) a linear combination thereof.

2. The inductor current emulation circuit of claim 1, wherein the bias voltage value is positively correlated with an average voltage value of the second emulation signal.

3. The inductor current emulation circuit of claim 2, wherein the average voltage value of the second emulation signal is positively correlated with the second voltage.

4. The inductor current emulation circuit of claim 1, wherein the plurality of state signals include a first state signal, a second state signal, a third state signal, a fourth state signal, and a fifth state signal, respectively corresponding to the following states:
(1) when the first state signal is asserted, the first emulation signal is positively correlated with the first voltage;
(2) when the second state signal is asserted, the first emulation signal is positively correlated with a difference between the first voltage and the second voltage;
(3) when the third state signal is asserted, the first emulation signal is positively correlated with a difference between the first voltage and one-half of the second voltage;
(4) when the fourth state signal is asserted, the first emulation signal is positively correlated with the difference between the first voltage and one-half of the second voltage; or
(5) when the fifth state signal is asserted, the first emulation signal is positively correlated with the ground potential.

5. The inductor current emulation circuit of claim 4, wherein the plurality of electrical connection states of the capacitor and the inductor respectively correspond to the following:
(1) when the first state signal is asserted, the inductor is electrically connected between the first voltage and the ground potential, and an upper end and a lower end of the capacitor are floating and electrically connected to the ground potential, respectively;
(2) when the second state signal is asserted, the inductor is electrically connected between the first voltage and the second voltage, and the upper end and lower end of the capacitor are electrically connected to the second voltage and floating, respectively;
(3) when the third state signal is asserted, the inductor and the capacitor are electrically connected in series between the first voltage and the ground potential;
(4) when the fourth state signal is asserted, the inductor and the capacitor are electrically connected in series between the first voltage and the second voltage; or
(5) when the fifth state signal is asserted, the inductor is electrically connected between the first voltage and floating, and the capacitor is floating.

6. The inductor current emulation circuit of claim 2, wherein the plurality of state signals include a first state signal, a second state signal, a third state signal and a fourth state signal;
wherein the first emulation signal has a first emulation voltage value during the first state signal being asserted, a second emulation voltage value during the second state signal being asserted, and a third emulation voltage value during the third state signal being asserted or the fourth state signal;
wherein the average voltage value of the second emulation signal is determined based on:
when the duty cycle is greater than ½, the average voltage value is determined according to the first emulation voltage value, the third emulation voltage value, and the duty cycle; or
when the duty cycle is less than ½, the average voltage value is determined according to the second emulation voltage value, the third emulation voltage value, and the duty cycle.

7. The inductor current emulation circuit of claim 1, wherein the filtering circuit includes:
a voltage-to-current conversion circuit, configured to generate a filtering current according to a difference between the first emulation signal and an average voltage value of the second emulation signal, thereby emulating the inductor voltage; and
an integration capacitor, configured to generate the second emulation signal based on an integration of the filtering current, thereby emulating the inductor current.

8. The inductor current emulation circuit of claim 3, wherein the filtering circuit includes:
a voltage-to-current conversion circuit, configured to generate a filtering current according to a difference between the first emulation signal and the average voltage value of the second emulation signal, thereby emulating the inductor voltage; and
an integration capacitor, configured to generate the second emulation signal based on an integration of the filtering current, thereby emulating the inductor current.

9. The inductor current emulation circuit of claim 7, wherein the voltage-to-current conversion circuit includes a filtering resistor configured to generate the filtering current, one end of the filtering resistor being configured to receive the first emulation signal, thereby generating the second emulation signal at the other end of the filtering resistor, the other end being coupled to the integration capacitor.

10. The inductor current emulation circuit of claim 4, wherein the selection circuit includes a plurality of selection switches, grouped into a first selection switch set, a second selection switch set, and a third selection switch set, and wherein the plurality of candidate voltages include first, second, third, fourth, and fifth candidate voltages;
wherein the plurality of selection switches operate as follows:
the first selection switch set is configured to select the first candidate voltage when the second state signal is asserted, and is configured to select the second candidate voltage when the first, third, or fourth state signal is asserted, to generate a first sub-emulation signal;
the second selection switch set is configured to select the third candidate voltage when the first state signal is asserted, and is configured to select the fourth candidate voltage when the second, third, or fourth state signal is asserted, to generate a second sub-emulation signal; and
the third selection switch set is configured to select the fifth candidate voltage when the fifth state signal is asserted;
wherein the first emulation signal is generated according to a voltage division between the first sub-emulation signal and the second sub-emulation signal when the first, second, third, or fourth state signal is asserted, and is generated according to the fifth candidate voltage when the fifth state signal is asserted.

11. The inductor current emulation circuit of claim 10, wherein the selection circuit further includes a logic circuit, configured to generate a plurality of control signals according to the plurality of state signals to control switching of the plurality of selection switches, thereby selecting the plurality of candidate voltages.

12. An emulation control method, configured to emulate an inductor current of a multi-level switching conversion circuit, wherein the multi-level switching conversion circuit is configured to periodically switch a capacitor and an inductor between a plurality of electrical connection states based on a plurality of switching signals in accordance with a duty cycle, thereby performing power conversion between a first voltage and a second voltage; the emulation control method comprising:
selecting a plurality of candidate voltages according to a plurality of state signals to generate a first emulation signal; and
generating a second emulation signal according to a difference between the first emulation signal and a bias voltage value, thereby emulating the inductor current;
wherein the difference between the first emulation signal and the bias voltage value is positively correlated with an inductor voltage across the inductor corresponding to one of the plurality of electrical connection states;
wherein the plurality of state signals are associated with the plurality of switching signals, each of the plurality of state signals corresponds to a corresponding one of the plurality of electrical connection states, and each of the plurality of candidate voltages is associated with (1) the first voltage, (2) the second voltage, (3) a ground potential, or (4) a linear combination thereof.

13. The emulation control method of claim 12, wherein the bias voltage value is positively correlated with an average voltage value of the second emulation signal.

14. The emulation control method of claim 13, wherein the average voltage value of the second emulation signal is positively correlated with the second voltage.

15. The emulation control method of claim 12, wherein the plurality of state signals include a first state signal, a second state signal, a third state signal, a fourth state signal, and a fifth state signal, respectively corresponding to the following states:
(1) when the first state signal is asserted, the first emulation signal is positively correlated with the first voltage;
(2) when the second state signal is asserted, the first emulation signal is positively correlated with a difference between the first voltage and the second voltage;
(3) when the third state signal is asserted, the first emulation signal is positively correlated with a difference between the first voltage and one-half of the second voltage;
(4) when the fourth state signal is asserted, the first emulation signal is positively correlated with the difference between the first voltage and one-half of the second voltage; or
(5) when the fifth state signal is asserted, the first emulation signal is positively correlated with the ground potential.

16. The emulation control method of claim 15, wherein the plurality of electrical connection states of the capacitor and the inductor respectively correspond to the following:
(1) when the first state signal is asserted, the inductor is electrically connected between the first voltage and the ground potential, and an upper end and a lower end of the capacitor are floating and electrically connected to the ground potential, respectively;
(2) when the second state signal is asserted, the inductor is electrically connected between the first voltage and the second voltage, and the upper end and the lower end of the capacitor are electrically connected to the second voltage and floating, respectively;
(3) when the third state signal is asserted, the inductor and the capacitor are electrically connected in series between the first voltage and the ground potential;
(4) when the fourth state signal is asserted, the inductor and the capacitor are electrically connected in series between the first voltage and the second voltage; or
(5) when the fifth state signal is asserted, the inductor is electrically connected between the first voltage and floating, and the capacitor is floating.

17. The emulation control method of claim 13, wherein the plurality of state signals include a first state signal, a second state signal, a third state signal and a fourth state signal;
wherein the first emulation signal has a first emulation voltage value during the first state signal being asserted, a second emulation voltage value during the second state signal being asserted, and a third emulation voltage value during the third state signal being asserted or the fourth state signal;
wherein a step of determining the average voltage value of the second emulation signal includes:
when the duty cycle is greater than ½, determining the average voltage value according to the first emulation voltage value, the third emulation voltage value, and the duty cycle; or
when the duty cycle is less than ½, determining the average voltage value according to the second emulation voltage value, the third emulation voltage value, and the duty cycle.

18. The emulation control method of claim 12, wherein a step of generating the second emulation signal includes:
generating a filtering signal according to a difference between the first emulation signal and an average voltage value of the second emulation signal, thereby emulating the inductor voltage; and
generating the second emulation signal according to an integration of the filtering signal, thereby emulating the inductor current.

19. The emulation control method of claim 15, wherein a step of selecting the plurality of candidate voltages includes:
selecting a first candidate voltage when the second state signal is asserted, and selecting a second candidate voltage when the first state signal, the third state signal, or the fourth state signal asserted, to generate a first sub-emulation signal;
selecting a third candidate voltage when the first state signal is asserted, and selecting a fourth candidate voltage when the second state signal, the third state signal, or the fourth state signal is asserted, to generate a second sub-emulation signal; and
selecting a fifth candidate voltage when the fifth state signal is asserted.

20. The emulation control method of claim 19, wherein a step of generating the first emulation signal includes:
generating the first emulation signal according to a voltage division between the first sub-emulation signal and the second sub-emulation signal when the first state signal, the second state signal, the third state signal, or the fourth state signal is asserted; and
generating the first emulation signal according to the fifth candidate voltage when the fifth state signal is asserted.
